(19) United States
(12) Patent Application Publication
(10) Pub. No.: US 2003/0011937 A1
(43) Pub. Date: Jan. 16, 2003

(54) Ramp assemblies to load/unload heads at the inner diameter of disk drives

(76) Inventors: Wuxing Gan, Fremont, CA (US); Venkat Ramesh Koka, Pleasanton, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 09/886,792

(22) Filed: Jun. 20, 2001

(51) Int. Cl. G11B 5/54

(52) U.S. Cl. 360/254.7

(57) ABSTRACT

A ramp assembly for loading and unloading of one or more sliders at the inner diameter of a disk drive. The disk drive has a base casting and one or more disk surfaces. The ramp assembly includes one or more projecting members, each projecting member including a disk-facing surface, a ramp which itself includes an inclined surface, a base member, which fastens to the base casting of the disk drive, and an upright member which connects the projecting member to the base member.

A second embodiment is a double-sided ramp assembly including an upper projecting member and a lower projecting member, having two disk-facing surfaces and two ramps, each of which includes an inclined plane, a second upright member, a horizontal support member, and a connecting upright.

A third embodiment uses multiple stories, where each double-sided ramp assembly is considered one story.

### TECHNICAL FIELD

This invention relates generally to magnetic disk data storage systems, and more particularly to the use of a ramp to facilitate the loading and unloading of sliders.

### BACKGROUND ART

In a computer system, magnetic disk drives are used to store and retrieve data for by using one or more magnetic heads positioned close to a rotating disk containing magnetic material which records the information. The write head operates to write data onto the disk by aligning magnetic poles of the magnetic material. A read head reads data by sensing the alignment of these poles. Typically, these are combined in a read/write head containing both devices. Because the magnetic fields are very small, it is important that the read and/or write head is located very near the surface of the disk. The closer the head can be placed to the disk surface, the greater the storage capacity of the disk can be. Heads are typically mounted to air bearing sliders which are specifically shaped so that when placed into an air-stream existing close to the surface of a rotating disk, the movement of the disk relative to the slider will provide a lifting force to cause it to fly above the disk. The lower surface of the slider is generally known as the Air Bearing Surface (ABS)

It is very important that the heads be maintained at a very precise and unvarying distance, known as “fly height” from the surface of the disk. Magnetic heads are usually mounted to sliders, which are in turn bonded to an actuator arm, which allows the slider to maintain a desired position relative to the disk surface. The actuator arm also enables movement of the slider across the disk surface to precise positions over individual data tracks of the disk.

Reducing the distance between the slider and the spinning disk is desirable in magnetic disk drive systems because bringing the read/write head closer to the magnetic medium improves signal strength and allows for increased density of data. However, as the fly height decreases, any contamination at the head-disk interface become more detrimental. Debris which may be microscopic in size may be collected over time on the ABS of the slider, and may ultimately cause the slider to crash into the magnetic disk. Therefore, reduction of contamination within the disk drive enclosure is a great and continuing concern within the disk drive industry.

A strategy that has been used to reduce collection of debris on the slider is to reduce the amount of contact between the slider and the disk when the disk drive is started and stopped. In a typical mode of operation, the read/write head is operated by a method known as Contact Start/Stop (CSS), which is shown in FIG. 2 (Prior Art). A disk drive 12 is shown having a central spindle 7, a hard disk 14, an actuator arm 16, and a slider 18 with a read/write head 20, all of which is within an enclosure 22. In this method, the slider 18 is parked in a landing zone 24 near the Inner Diameter (ID) 26 of the disk 14. The actuator arm 16 moves the slider 14 to this landing zone 24, and then the rotational speed of the disk 14 slows gradually. The positive pressure at the ABS, on the side of the slider 18 which faces the disk 14 gradually decreases until the slider 18 comes to rest, finally resting on the surface of the disk 14. When the disk 14 was spun again, the air bearing would form and the slider 18 would lift back off of the surface. However, the friction and wear that created amounts of debris which became unacceptable as fly heights became even lower. In order to reduce friction and debris accumulation, the landing zone 24 was first improved by making it textured, in order to reduce the contact area between the slider 18 and the disk 14, (see U.S. Pat. No. 5,729,399 to Albrecht). This technique decreased contamination, but even this reduced amount of debris ultimately was found to be undesirable as the fly height became still lower.

Recently, another mode of operation has been developed, called Load/Unload (see FIGS. 3-5). In this mode, when the head 20 is to be parked, as on start-up or power-down, the slider 18 is carried by the actuator arm 16 to the Outer Diameter (OD) 28 of the disk 14. There is a small ramp 30, up which the actuator arm 16 is carried, and then the arm 16 or some portion thereof comes to rest a short distance above the surface of the disk 14. The slider 18 thus never contacts the disk surface, and a certain amount of wear on the slider is thus avoided. To aid in this operation a tab 32 may be attached to the slider 18, which may serve as the actual contact point between the actuator arm 16 and the ramp 30. Structurally, the slider 18 is commonly attached to the actuator arm 16 by a thin flexure 34, the resulting assembly being typically known as a Head Gimbal Assembly (HGA) 36. FIGS. 4 and 5 show a disk stack 38 having a head stack 40, the read/write heads 20 of which address the upper and lower surfaces of the individual disks 14. FIG. 6 shows a simplified detail end view of one HGA 36, with a ramp 30, with direction arrows to indicate the relative motion of the HGA 36. The tab 32 is shown as having a rounded bottom surface, which will slide up the inclined plane surface 42 of the ramp 30, thus causing the slider 18 and head 20 to rise from the surface of the disk 14. As shown, the tab 32 may be rounded to provide a minimized contact area with the ramp 30.

In the inevitable march towards lower fly heights and greater areal densities, it has been found that performing a Load/Unload operation at the OD has certain disadvantages as well. It is well known that as the airflow at the ABS is increased, the slider will produce greater lift and thus raise to a higher position above the disk surface. This causes the slider to vary its height as its location along the radius of the disk is changed. The closer to the center of the disk the slower the airflow will be, the lower the lift force and thus the lower the slider will fly. The closer to the outer edge the slider is, the faster the airflow, the greater the lift force and the higher the slider will fly. In order to minimize fluxuations in flying height, it has become the practice to contour the ABS so as to create regions of negative pressure, that is areas of sub-ambient pressure, which act to create a balancing “suction” force which draws the slider downwards towards the disk surface. These are generally formed by creating cavities into which the air-streams can accelerate, thus causing a localized drop in pressure in these cavity areas. As discussed above, the parked position of the arm is physically elevated about the level of the disk, so it is necessary to lift the arm, including the slider, from proximity with the disk. The slider is attached to the arm by a flexible suspension membrane, or flexure, as discussed above, which, in order to minimize weight and provide flexibility, is made to be very thin. In sliders with an ABS which uses negative pressure areas to maintain a constant fly height, the negative pressure naturally opposes the lifting of the slider from the disk surface. If the membrane is fragile enough, or if the negative pressure force is great enough, the membrane can be torn or damaged as the slider is pulled away from the disk surface. This negative pressure force increases with increased disk velocity, and thus is greater at the OD of the disk where the linear velocity is greater than near the Inner Diameter (ID). Thus, there is less force required and less risk of damage to the flexure if a Load/Unload operation is performed at the ID than at the OD. Additionally, where there is a smaller force required, there will be a smoother operation, less vibration and less potential for damage when unload is performed at the ID.

Another concern is that a certain disk space is required for the parking space. Since the length of the circumference varies directly with diameter, for a data track of constant width, the circumferential area of the track space, which is used for parking will be much greater at the OD than at the ID. This parking space cannot be used for data storage, so less usable disk space is wasted when a Load/Unload operation is performed at the ID than the OD.

There have been several previous uses of the ID as a Load/Unload platform. U.S. Pat. No. 5,574,604 to Berg et al., U.S. Pat. No. 5,644,451 to Chen, U.S. Pat. No. 5,526,206 to Shimuzu, U.S. Pat. No. 5,701,219 to Shafé, and U.S. Pat. No. 4,752,848 to Garcia et al., are all examples. Once again, there are certain disadvantages to these approaches. The modern approach to disk drive construction uses multiple heads which address multiple disks in a stack, and usually both surfaces of each disk. Thus, there is generally a need to park each of these heads on a ramp of its own. The patents to Shimuzu, and Shafé disclose ID ramps which are attached to the cover, or housing or base plate in a manner that allows access to only one disk surface.

There is also a need for stability during the Load/Unload operation. As discussed above, vibrations during this operation can be detrimental to operation and possibly even hazardous to the disk drive. A Load/Unload ramp which is not firmly anchored will naturally provide more opportunity for vibration. The most substantial structure in the disk drive, and thus the firmest anchoring point, is generally the base casting. Thus any ramp, or multiple ramps, in order to minimize vibrations, should preferably be attached to this base casting.

Of the prior art patents referred to above, Chan and Garcia both disclose a rotating ramp which is basically an elevated portion of the central spindle with an inclined surface leading to the parking area. Thus there are the same potential hazards of contamination as particles are removed by friction when the tab, tang or arm portion contacts the rotating ramp surface. This seems to be nothing more than a variation on the Contact Start-Stop configuration.

The patent to Berg discloses ramps which are attached to the cover, or spindle and a second ramp, fashioned as a mirror image attached to the base plate in order to address both sides of a disk. There remains the problem of stability for the upper ramp and the impossibility of addressing surfaces other than the upper and lower surface of a single disk.

An additional concern is for the ability to retro-fit existing disk drives. There are many disk drives that have been manufactured without an ID ramp, and for which it is desirable to add this feature without having to disassemble and rebuild them.

Thus there is a need for a retro-fittable ramp structure which anchors securely to the disk drive base plate, which can be made to accommodate multiple heads addressing multiple surfaces in a stack of disks, and which provides Load/Unload parking at the Inner Diameter of the disks.

### SUMMARY OF THE INVENTION

A ramp assembly for loading and unloading of one or more sliders at the inner diameter of a disk drive is disclosed. The disk drive generally has a base casting and one or more disk surfaces. The ramp assembly includes one or more projecting members, each projecting member including a disk-facing surface and a ramp which itself includes an inclined surface, which slopes away from said disk surface. The ramp assembly also includes a base member, which fastens to the base casting of the disk drive, and an upright member which connects the projecting member to the base member.

A second embodiment is a double-sided ramp assembly including an upper projecting member and a lower projecting member. The double-sided ramp assembly includes two disk-facing surfaces and two ramps, each of which includes an inclined plane, a second upright member, a horizontal support member, and a connecting upright.

A third embodiment uses multiple stories, where each double-sided ramp assembly is considered one story. The connecting upright is positioned outside the outer diameter of the disks, and multiple horizontal support members reach to near the inner diameter of the disks to position the projecting members with the ramps near the surface of the inner diameter of the disks.

### DISCLOSURE OF INVENTION

Accordingly, it is an object of the present invention to provide a ramp structure which allows Load/Unload parking of disk drive heads at the Inner Diameter of disk drive disks.

Another object of the invention is to provide a ramp structure which is easily retro-fittable to existing disk drives.

And another object of the invention is to provide a ramp structure which can be used to address both sides of a single disk or multiple disks in a stack.

Briefly, one preferred embodiment of the present invention is a ramp assembly for loading and unloading of one or more sliders at the inner diameter of a disk drive. The disk drive generally has a base casting and one or more disk surfaces. The ramp assembly includes one or more projecting members, each projecting member including a disk-facing surface and a ramp which itself includes an inclined surface, which slopes away from said disk surface. The ramp assembly also includes a base member, which fastens to the base casting of the disk drive, and an upright member which connects the projecting member to the base member.

A second embodiment is a double-sided ramp assembly including an upper projecting member and a lower projecting member. The double-sided ramp assembly includes two disk-facing surfaces and two ramps, each of which includes an inclined plane, a second upright member, a horizontal support member, and a connecting upright.

A third embodiment uses multiple stories, where each double-sided ramp assembly is considered one story. The connecting upright is positioned outside the outer diameter of the disks, and multiple horizontal support members reach to near the inner diameter of the disks to position the projecting members with the ramps near the surface of the inner diameter of the disks.

A disk drive having ramp assemblies and a method of operation are also disclosed.

An advantage of the present invention is that there is less usable disk space taken up by the parking area.

Another advantage of the invention is that vibrations are minimized during the Load/Unload operation by anchoring the ramp structure to the base plate.

And another advantage of the invention is that the ramp structure can be created to serve a single disk or can be made in convenient multiples to serve multiple disks in a stack.

A further advantage of the present invention is that the ramp structure can serve to separate the heads to secure them for shipping or storage.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows a simplified top plan view of a magnetic storage device;

FIG. 2 illustrates a simplified top plan view of a disk drive of the prior art, which uses Contact Start-stop parking;

FIG. 3 illustrates a simplified plan view of a disk drive of the prior art, which uses load/unload parking;

FIG. 4 shows an isometric front view of a disk drive of the prior art, which uses load/unload parking;

FIG. 5 shows a cut-away view as taken in line 5-5 of FIG. 4, of a head stack and disk stack;

FIG. 6 illustrates a simplified front view diagram of the actuator arm, slider and suspension membrane and a ramp of the prior art which are configured for unloading operations;

FIG. 7 shows a side plan view of a first embodiment of a ramp assembly of the present invention for use with a single head which addresses a single disk surface;

FIG. 8 illustrates a side plan view of a second embodiment of a ramp assembly of the present invention for use with a double head which addresses both sides of a disk surface;

FIG. 9 shows a side plan view of a third embodiment of a ramp assembly of the present invention for use with a multiple heads which address both sides of a multi-story disk stack;

FIG. 10 shows an isometric view of the first embodiment of a ramp assembly of the present invention for use with a single head which addresses a single disk surface;

FIG. 11 illustrates an isometric view of the second embodiment of a ramp assembly of the present invention for use with a double head which addresses both sides of a disk surface;

FIG. 12 shows an isometric view of a third embodiment of a ramp assembly of the present invention for use with a multiple heads which address both sides of a multi-story disk stack;

FIG. 13 illustrates a variation in the ramp structure as seen in detail circle A of FIG. 12;

FIG. 14 shows a second variation in the ramp structure as seen in detail circle A of FIG. 12; and

FIG. 15 is a flow chart of a method for unloading a disk drive head or heads from a disk or disk stack.

### BEST MODE FOR CARRYING OUT THE INVENTION

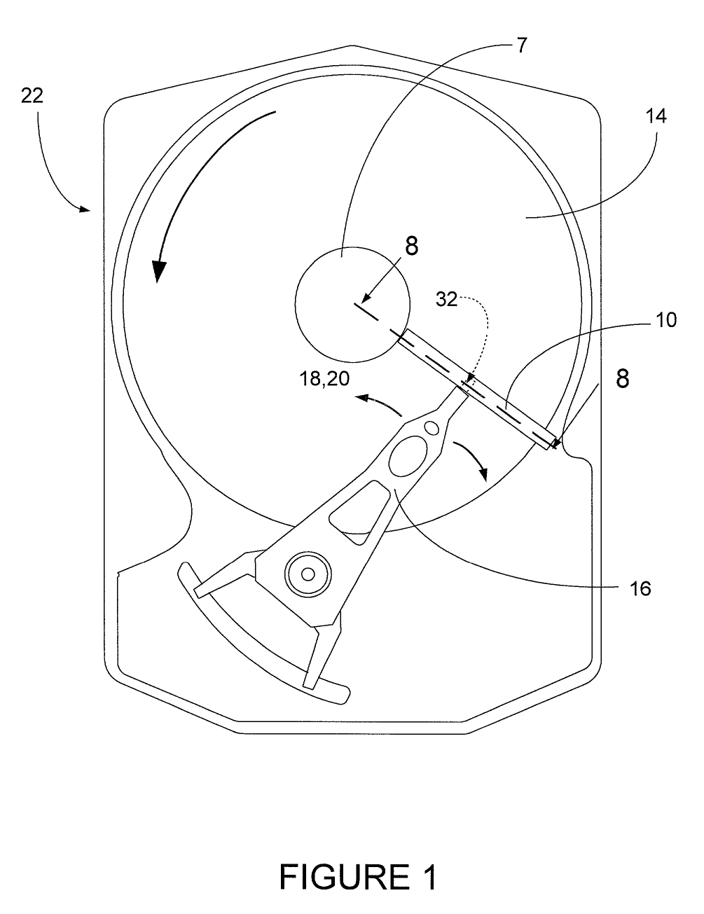

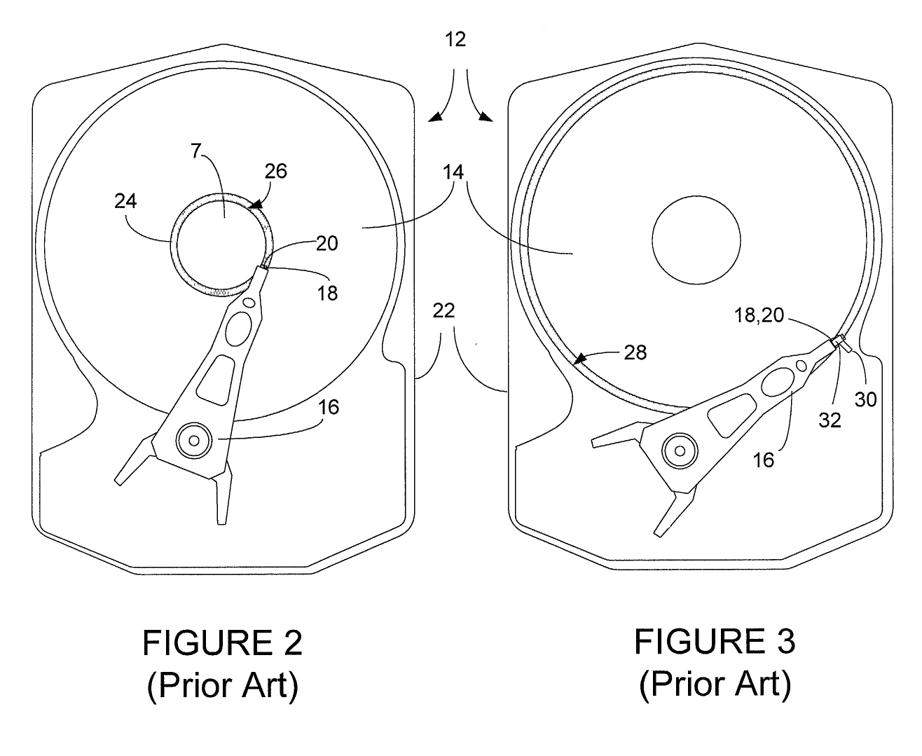

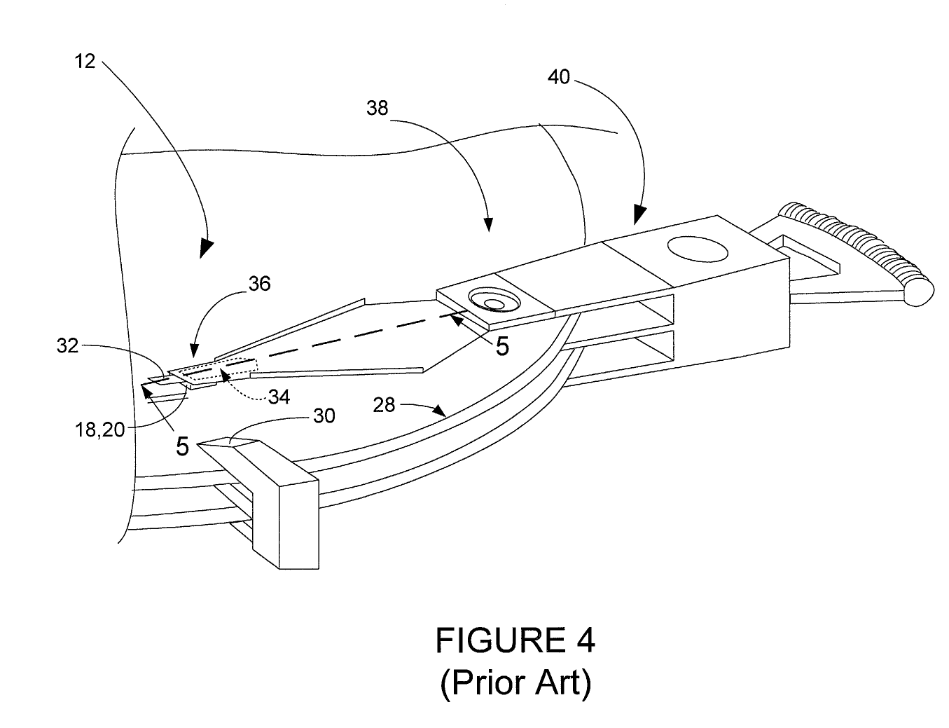

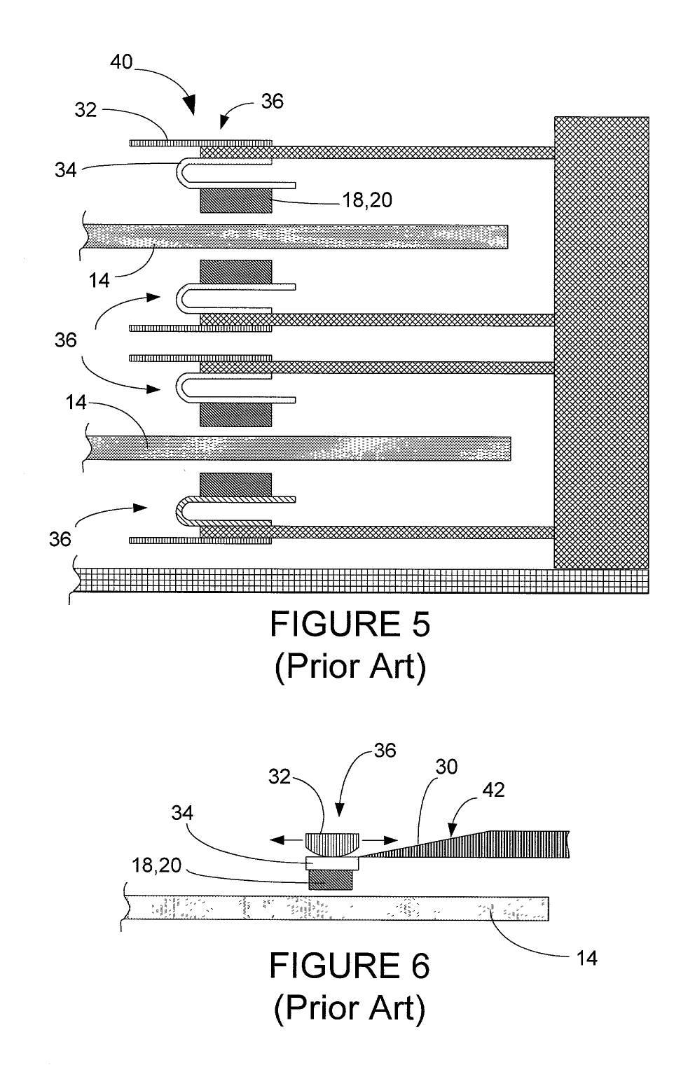

A preferred embodiment of the present invention is a retro-fittable, single or multi-stage ramp for load/unload operations at the disk inner diameter. As illustrated in the various drawings herein, and particularly in the view of FIG. 1, a form of this preferred embodiment of the inventive device is depicted by the general reference character 10.

FIG. 1 shows a simplified top plan view of a hard disk drive 12, which generally includes a disk 14, an actuator arm 16, which supports a slider 18, having an embedded head 20, and being contained within an enclosure 22. A retrofittable ramp structure 10 is shown which obscures a tab 32, shown in dashed line.

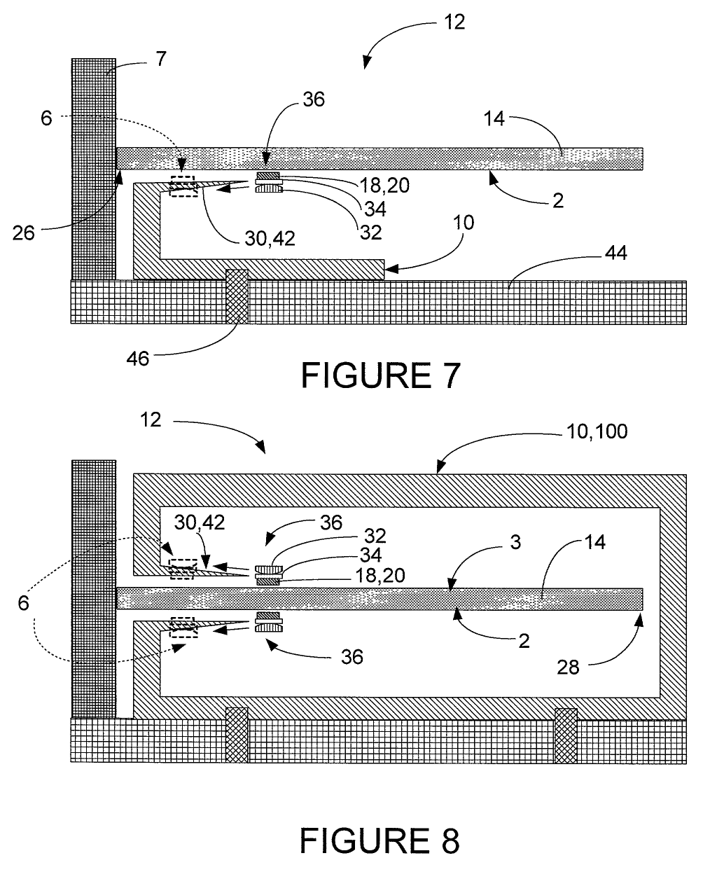

FIG. 7 shows simplified side plan view of a disk drive 12 having a single-sided disk 14 and a single-surface retrofittable ramp assembly 10, the view assumed to be looking straight on at the end of the actuator arm, which is not shown for simplicity. A single Head Gimbal Assembly (HGA) 36 is seen positioned near the lower surface 2 of the disk 14. The HGA 36 includes a slider 18 with a head 20, which is attached to the arm (not shown) by a flexure 34. A tab 32 is shown which will be assumed to be the contact point with the ramp 30 for load/unload operations, although this is not required, and the ramp 30 may in fact engage other portions of the arm.

The retrofittable single-surface ramp assembly 10 is shown in more detail in FIG. 10, which is an isometric view of the ramp assembly 10 removed from the disk drive 12. Referring to both FIGS. 7 and 10, the ramp assembly 10 includes a base member 54 having a bottom surface 56, a first upright member 58, and a projecting member 60, having a disk-facing surface 62 and an inclined surface 42. The bottom surface 56 contacts the base casting 44 and is secured by fasteners 46.

When an unload operation is performed, the HGA 36 is moved toward the ID 26 until the tab 32 or other part contacts the inclined surface 42. The term “inclined” in this specification is used also for a surface which slopes downward, as here, as well as upwards, as when used with an upper disk surface. The term “inclined” will be used to mean “sloping away from the disk surface”. As the tab 32 contacts the ramp 30, the slider 18, with the head 20, is moved away from the disk surface 2, until it comes to rest in parked position 6.

The ramp assemblies are preferably used with multiple disks in a disk stack, or at least multiple sides of a disk. There must be a read/write head for each disk surface on which information is to be recorded or read, and a ramp assembly for each head. FIGS. 8 and 11 show a retrofittable ramp assembly 10 which is used with a single double-sided disk 14, having a lower surface 2 and an upper surface 3. This double-sided single disk embodiment will be noted as a double-sided ramp 100. The double-sided ramp assembly 100 thus includes 2 projecting members 60, each with a disk-facing surface 62 and an inclined surface 42. The base member 54 again has a bottom surface, which is elongated to reach beyond the outer diameter 28 of the disk 14, but which is still included inside the enclosure 22 (see FIG. 1). The double-sided ramp 100 includes a horizontal support member 64 which attaches through a connecting upright 66 to the base member 56. The upper projecting member 68 of the two projecting members 60 connects to the horizontal support member 64 by a second upright member 70. In a similar manner to before, the sliders 18 move away from the disk surface 2,3, as the two HGAs 36 move to the inner diameter 26, until they reach the parked position 6 (shown in dashed lines).

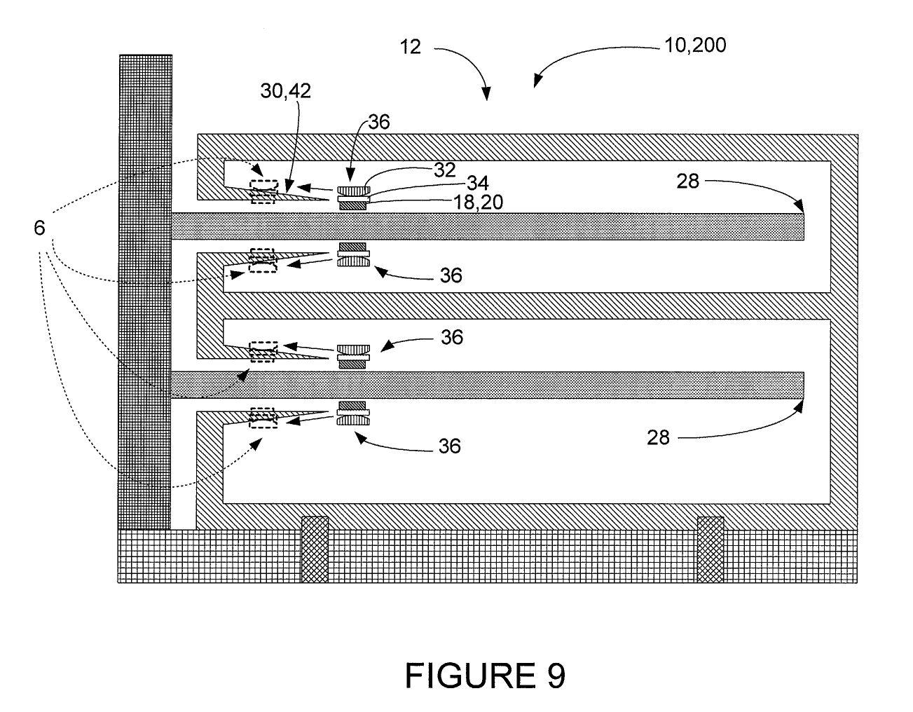

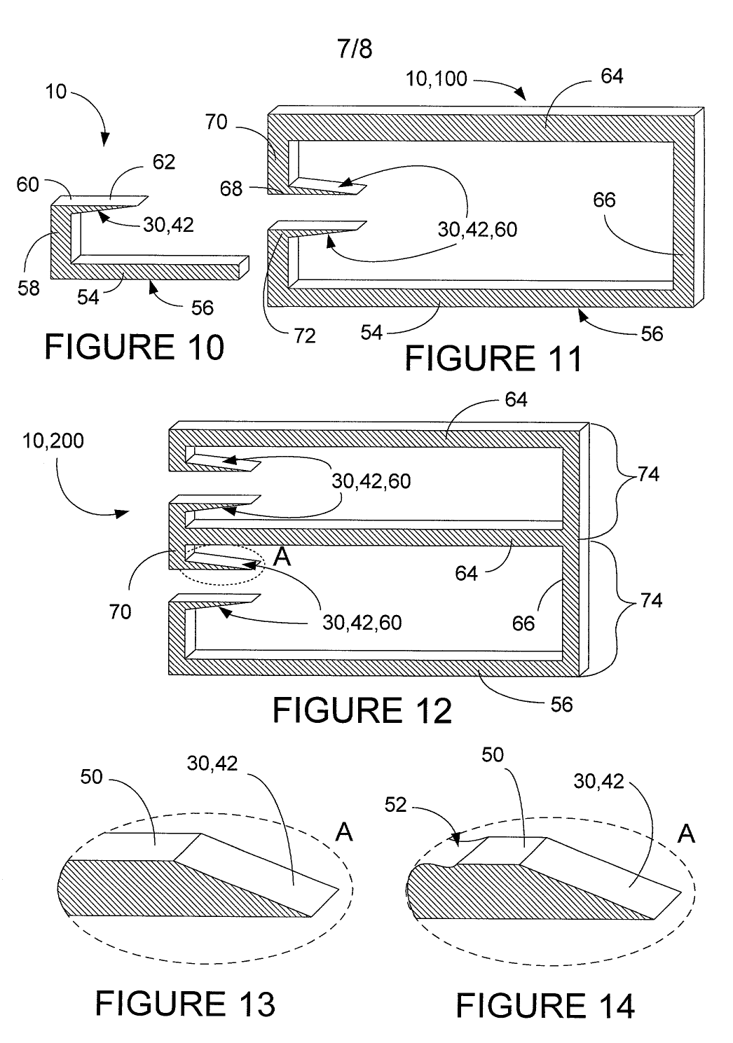

As mentioned before, the disks can be configured into stacks, which are addressed by a stack of heads, one for each side which contains information. The double ramps 100 can thus be extended in multiples of two ramps, and each set of double ramps 100 which can address a double-sided disk will be referred to as a story 70. One such multiple-story ramp 200 is shown in FIGS. 9 and 12, in this case a two-story ramp, for use with 2 disks. This can, of course, be extended to 3 or more stories, following the same pattern. By adding further horizontal support members 64 which reach to a connecting upright 66 positioned beyond the outer diameter 28 of the disks 14, support is provided for additional inclined surfaces 42 for each disk surface.

FIGS. 13 and 14 show detail views of the area enclosed in area A of FIG. 12, and show variations which may be included in alternate embodiments. FIG. 13 shows a flat platform area 50 which may be optionally included between the inclined surface 42 and the second upright member 70. This can help retain the HGA 36 in the parked position 6. This concept is taken further in FIG. 14, where a retaining notch 52 is included after a short flat platform portion 50, which helps to retain the tab or other arm portion in the parked position.

The various ramps assemblies 10, 100, 200 described above can be injection molded, or extruded or made of machined material. The ramp assemblies 10, 100, 200 can be mounted to the base casting 44 by fastening screws through datum holes provided on the casting 44 into the base member 54 of the ramp assemblies 10, 100, 200.

The present invention 10 thus solves the problem of providing a load/unload platform at the inner diameter of the disks, and has the advantage of taking up less useable disk space. It allows positioning of load/unloads ramps at the disk inner diameter between disks in a stack, and avoids the use of ramps which attach to the central spindle or top cover, which provide less stability and more risk of damage through catastrophic head crashes. Although it is possible to place a circular exit ramp as a spacer near the central spindle, contact between the stationary head and a rotating surface will almost inevitably cause friction, which will cause abrasion of minute particles, causing contamination of internal parts. This is precisely the disadvantage which caused Contact Start-Stop configuration, discussed above, to be disfavored. An HGA, having only a very small relative velocity, which parks on a stationary ramp will generate a much smaller amount of contaminants, and thus is expected to provide much improved performance, compared to one with CSS or a rotating ramp structure.

When disk drives are packaged for shipment, the heads must be held in position away from the disk surfaces, so that vibrations cannot cause damage to the heads or the disks. Once parked, the ramp assemblies 10, 100, 200 can act as head separators to protect the heads in a head stack.

As the title implies, the ability to retrofit these ramp assemblies 10, 100, 200 to existing disk drives is a major advantage. This can apply to disk drives “in the field” or to ones for which all or some of the major components have been pre-fabricated before supply to another manufacturer who installs the completed disk drive. In either case there is relatively little disassembly required in order to install the ramp assemblies, and construction is mostly a matter of attaching the base member of the ramp assembly to the base casting of the disk drive.

Of course, the ramp assemblies' use is not restricted to retrofit operations. The ease of attachment and use simplifies any fabrication operation in which they are involved, and the benefits of decreased contamination and increased usable disk space will benefit almost any disk drive device.

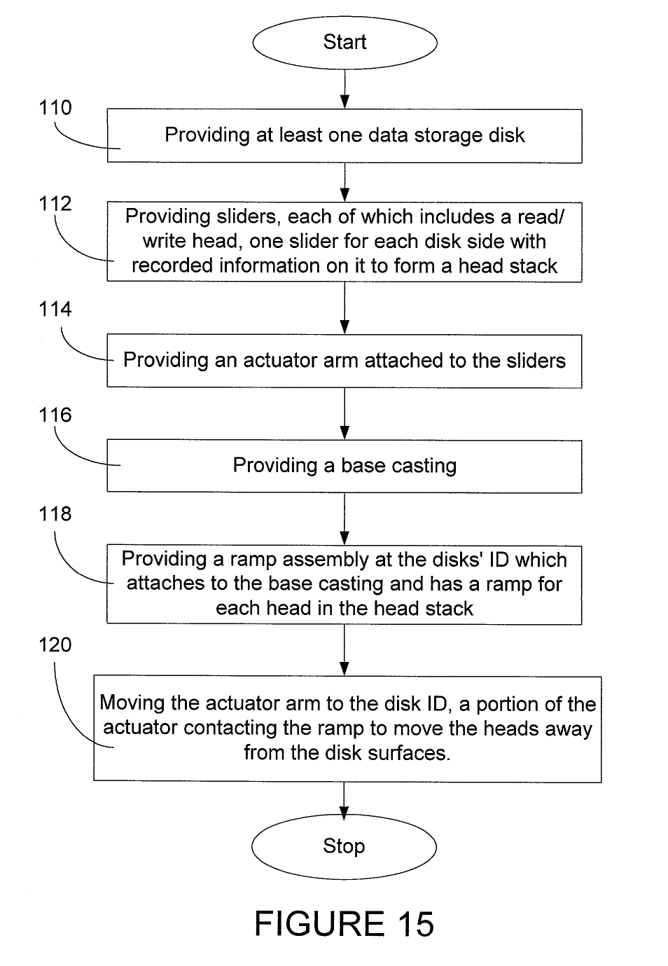

FIG. 15 shows a flow chart illustrating the major steps of a method for using the ramp assemblies of the present invention for unloading one slider or a stack of sliders. At least one data storage disk is provided 110, each disk having potentially two sides on which information can be recorded. Sliders are provided, each of which includes a read/write head 112, where there is one slider for each disk side which has information read from or written to it. An actuator arm is provided 114 which is attached to all the sliders in the stack of sliders. A base casting is also provided 116 and a ramp assembly, which can have multiple ramps located at the disks ID, attaches to the base casting 188. The actuator arm is then moved to the disk ID, a portion of this arm moves up the ramp and the heads are moved away from the disk surfaces 120. It is understood that the ramp assemblies can be single, double-sided, or multi-storied, and can have a flat platform portion or a retaining notch as described previously, and the actuator arm can have a tab extension which may be rounded to minimize contact with the ramp.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

RAMP ASSEMBLIES TO LOAD/UNLOAD HEADS AT THE INNER
DIAMETER OF DISK DRIVES
Inventors: GAN, Wuxing and KOKA, Ramesh
Atty. ref.: 60421-304501 (READPO45), Read-Rite Log #1646
THIS CORRESPONDENCE CHART IS FOR EASE OF
UNDERSTANDING AND INFORMATIONAL PURPOSES ONLY,
AND DOES NOT FORM A PART OF THE
FORMAL PATENT APPLICATION.

| | |
|---|---|
| 10 | ramp assembly |
| 12 | disk drive |
| 14 | disk |
| 16 | actuator arm |
| 18 | slider |
| 20 | read/write head |
| 22 | enclosure |
| 24 | Contact Start-Stop landing zone |
| 26 | Inner Diameter (ID) |
| 28 | Outer Diameter (OD) |
| 30 | ramp |
| 32 | tab |
| 34 | flexure |
| 36 | Head Gimbal Assembly (HGA) |
| 38 | disk stack |
| 40 | head stack |
| 42 | inclined plane surface |
| 44 | base casting |
| 46 | fastener |
| 50 | flat platform portion |
| 52 | retaining notch |
| 54 | base member |
| 56 | bottom surface |
| 58 | first upright member |
| 60 | projecting member |
| 62 | disk-facing surface |
| 64 | horizontal support member |
| 66 | connecting upright |
| 68 | upper projecting member |
| 70 | second upright |
| 72 | lower projecting member |
| 74 | story |
| 100 | double-sided ramp assembly |
| 200 | multiple-story ramp assembly |

What is claimed is:

1. A ramp assembly for loading and unloading of at least one slider at the inner diameter of a disk drive having a base casting and at least one disk surface, the ramp assembly comprising:
at least one projecting member, each projecting member including a disk-facing surface and at least one ramp which includes an inclined surface, which slopes away from said disk surface;
a base member, which fastens to said base casting of said disk drive; and
an upright member which connects said projecting member to said base member and which keeps it in fixed spatial relation to said at least one disk surface.

2. The ramp assembly of claim 1, wherein said at least one projecting member includes an upper projecting member and a lower projecting member in a double-sided ramp assembly, for use with a double-sided disk, said double-sided ramp assembly having two disk-facing surfaces which face the surfaces of said disk, and two ramps, each of which include an inclined plane which slopes away from said disk surfaces, said double-sided ramp assembly further comprising:
a second upright member, which connects to said upper projecting member;
a horizontal support member, which connects to said second upright member; and
a connecting upright which connects between said horizontal support member and said base member.

3. The ramp assembly of claim 2, wherein:
said double-sided ramp collectively comprises a story; and
said ramp assembly is a multi-story ramp assembly.

4. The ramp assembly of claim 1, wherein:
said ramp includes a flat platform.

5. The ramp assembly of claim 1, wherein:
said ramp includes a retaining notch.

6. The ramp assembly of claim 1, wherein:
said at least one slider is attached to an actuator arm, said actuator arm further including a tab which extends said actuator arm; and
said at least one ramp of said ramp assembly is positioned to contact said tab, so that said tab moves along said ramp as said actuator arm approaches said inner diameter, and said slider is moved away from the surface of said disk.

7. The ramp assembly of claim 6, wherein:
said tab is rounded to minimize contact with said ramp.

8. A disk drive for storing and retrieving data, comprising:
an enclosure;
a base casting;
at least one disk, having at least one surface;
a slider including a read/write head;
an actuator arm attached to said slider for positioning said read/write head proximate to said at least one surface of said disk; and
a ramp assembly for loading and unloading of at least one slider at the inner diameter of said disk drive, said ramp assembly including:
at least one projecting member, each projecting member including a disk-facing surface and at least one ramp, each of which includes an inclined surface which slopes away from the disk surface;
a base member, which fastens to said base casting of said disk drive; and
an upright member which connects said projecting member to said base member and which keeps it in fixed spatial relation to said at least one disk surface.

9. The disk drive of claim 8, wherein said at least one projecting member includes an upper projecting member and a lower projecting member in a double-sided ramp assembly, for use with a double-sided disk, said double-sided ramp assembly having two disk-facing surfaces which face the surfaces of the disk, and two ramps which include inclined planes which slope away from said disk surfaces, said ramp assembly further comprising:
a second upright member, which connects to said upper projecting member;
a horizontal support member, which connects to said second upright member; and
a connecting upright which connects to said horizontal support member and said base member.

10. The disk drive of claim 9, wherein:
said double-sided ramp collectively comprises a story; and
said ramp assembly is a multi-story ramp assembly.

11. The disk drive of claim 8, wherein:
said ramp includes a flat platform.

12. The disk drive of claim 8, wherein:
said ramp includes a retaining notch.

13. The disk drive of claim 8, further comprising:
a tab which extends said actuator arm, said at least one ramp of said ramp assembly being positioned to contact said tab, so that said tab moves along said ramp as said actuator arm approaches said inner diameter, and said read/write head is moved away from the surface of said disk.

14. The disk drive of claim 13, wherein:
said tab is rounded to minimize contact with said ramp.

15. A method for unloading a slider, comprising the steps of:
a) providing at least one data storage disk, having at least one surface and an inner diameter, disposed within an enclosure;
b) providing a slider including a read/write head;
c) providing an actuator arm attached to said slider for positioning said read/write head proximate to said at least one surface of said disk;
d) providing a base casting;
e) providing a ramp assembly for loading and unloading of at least one slider at the inner diameter of said disk drive, the ramp assembly including:
at least one projecting member, each projecting member including a disk-facing surface and a ramp which includes an inclined surface which slopes away from the disk surface;
a base member, which fastens to said base casting of said disk drive; and
an upright member which connects said projecting member to said base member and which keeps it in fixed spatial relation to said at least one disk surface;
f) moving said actuator arm toward said inner diameter, said ramp being positioned so that a portion of said actuator arm contacts said ramp and moves said read/write head away from said surface of said disk to place the read/write head in a parked position.

16. The method of unloading of claim 15, wherein said at least one projecting member is an upper projecting member and a lower projecting member in a double-sided ramp assembly, for use with a double-sided disk, said double-sided ramp assembly having two disk-facing surfaces which face the surfaces of the disk, and two ramps which include inclined planes which slope away from said disk surfaces, said ramp assembly further comprising:
a second upright member, which connects to said upper projecting member;
a horizontal support member, which connects to said second upright member; and
a connecting upright which connects to said horizontal support member and said base member.

17. The method of unloading of claim 16, wherein:
said double-sided ramp collectively comprises a story; and
said ramp assembly is a multi-story ramp assembly.

18. The method of unloading of claim 16, wherein:
said ramp includes a flat platform.

19. The method of unloading of claim 16, wherein:
said ramp includes a retaining notch.

20. The method of unloading of claim 16, wherein:
said at least one slider is attached to an actuator arm, said actuator arm further including a tab which extends said actuator arm; and
said at least one ramp of said ramp assembly is positioned to contact said tab, so that said tab moves along said ramp as said actuator arm approaches said inner diameter, and said slider is moved away from the surface of said disk.

21. The method of unloading of claim 20, wherein:
said tab is rounded to minimize contact with said ramp.

22. A ramp assembly for loading and unloading of multiple sliders at the inner diameter of a disk drive having a base casting and at least one disk surface, the disk surfaces having an inner diameter and an outer diameter, the ramp assembly comprising:
a plurality of projecting members, each projecting member including a disk-facing surface and at least one ramp which includes an inclined surface, which slopes away from said disk surface;
a base member, which fastens to said base casting of said disk drive;
at least one horizontal support member;
a plurality of upright members which connect each of said projecting members to one of said at least one horizontal support member; and
a connecting upright which connects between said at least one horizontal support member and said base member, said connecting upright being positioned beyond the outer diameter of said disk surfaces, and the horizontal support members extending to position each of said ramps proximate to said disk surfaces' inner diameter.
